(19) United States
(12) Patent Application Publication
(10) Pub. No.: US 2021/0368439 A1
(43) Pub. Date: Nov. 25, 2021

(54) WLAN WAKE UP RADIO WITH BACKSCATTERING

(71) Applicant: QUALCOMM Incorporated, San Diego, CA (US)

(72) Inventors: Anand Antony KARIMARUTHUMKAL, Chennai (IN); Ayushman SARMA, Bengaluru (IN); Narayanan MURUGAN, Chennai (IN)

(21) Appl. No.: 16/878,253

(22) Filed: May 19, 2020

(51) Int. Cl. H04W 52/02; H04W 80/02; H04W 76/11; H04L 5/00

(52) U.S. Cl. CPC H04W 52/0229; H04L 5/0055; H04W 76/11; H04W 80/02

(57) ABSTRACT

This disclosure provides methods, devices and systems for a wireless local area network (WLAN) wake up radio (WUR) with backscattering. A method for wireless communication is provided that may be performed by a backscattering device. The backscattering device may receive a wake up radio (WUR) trigger packet from an access point (AP) indicating one or more parameters for backscattering transmission. The backscattering device receive one or more power packets from the AP on a first frequency channel and send one or more backscattered transmissions on a second frequency channel based on the one or more power packets and the one or more parameters.

### TECHNICAL FIELD

This disclosure relates generally to wireless communication, and more specifically, to a wireless local area network (WLAN) wake up radio (WUR) with backscattering.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Some WLAN systems, such as IEEE 802.11ba systems, use wake-up radio (WUR) signaling where a low power On-Off Keying (OOK) transmitter can “wake-up” a receiver module having a secondary OOK receiver.

Some systems, such as some Wi-Fi systems, use backscattering. With backscattering, a radio can transmit a signal in a channel by using power from a different channel in the same Wi-Fi band (e.g., in the 2.4 GHz or 5 GHz band). A driver AP transmits packets (referred to as “power packets”) with known data. This data is modulated by the backscatter and transmitted either to the driver AP or to some other device which can decode the modulated data. Radio-frequency identification (RFID) is one example of a technology that uses backscattering. Backscattering may be used for low-power, low-distance communication (e.g., with amplitude shift keying (ASK) techniques.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication by a backscattering device. The method generally includes receiving a wake up radio (WUR) trigger packet from an access point (AP) indicating one or more parameters for backscattering transmission. The method generally includes receiving one or more power packets from the AP on a first frequency channel. The method generally includes sending one or more backscattered transmissions on a second frequency channel based on the one or more power packets and the one or more parameters.

Another innovative aspect of the subject matter described in this disclosure can be implemented in a wireless communication device. The wireless communication device includes at least one modem and at least one processor communicatively coupled with the at least one modem. The at least one memory communicatively coupled with the at least one processor and storing processor-readable code that, when executed by the at least one processor in conjunction with the at least one modem, is configured to receive a WUR trigger packet from an AP indicating one or more parameters for backscattering transmission; receive one or more power packets from the AP on a first frequency channel; and send one or more backscattered transmissions on a second frequency channel based on the one or more power packets and the one or more parameters.

Another innovative aspect of the subject matter described in this disclosure can be implemented in a wireless communication device. The wireless communication device includes a mobile station. The mobile station includes at least one transceiver coupled to at least one modem; at least one antenna coupled to the at least one transceiver to wirelessly transmit signals output from the at least one transceiver and to wirelessly receive signals for input into the at least one transceiver; and a housing that encompasses the at least one modem, the at least one processor, the at least one memory, the at least one transceiver and at least a portion of the at least one antenna. The at least one memory communicatively coupled with the at least one processor and storing processor-readable code that, when executed by the at least one processor in conjunction with the at least one modem, is configured to receive a WUR trigger packet from an AP indicating one or more parameters for backscattering transmission; receive one or more power packets from the AP on a first frequency channel; and send one or more backscattered transmissions on a second frequency channel based on the one or more power packets and the one or more parameters.

In some implementations, the backscattering device does not perform backscattering transmission for any received packet when a WUR trigger packet indicating the one or more parameters is not received.

In some implementations, the one or more parameters indicate a first duration from the WUR trigger packet until detecting of the one or more the power packets starts, a second duration indicating a duration of a preamble of the one or more power packets during each of which backscattering is without modulation of data of the backscattering device on the second frequency channel, a third duration for the one or more backscattered transmissions, an address of the backscattering device, the second frequency channel for the one or more backscattered transmissions, or a combination thereof.

In some implementations, the one or more parameters schedule a plurality of backscattering devices using time division multiplexing (TDM), frequency division multiplexing (FDM), or both.

In some implementations, the WUR trigger packet comprises a medium access control (MAC) frame including a 3-bit type identifier (ID) field with a reserved value, an 8-bit field indicating the first duration, a 9-bit field indicating an ID of the AP comprising 9 least significant bits (LSBs) of a compressed basic service set ID (BSSID), a 6-bit field indicating the address of the backscatter device, a 6-bit field indicating the second duration, a 1-bit shift field and a 4-bit channel offset field indicating the second frequency channel, a 10-bit field indicating the third duration, and a 16-bit frame check sequence (FCS) field.

In some implementations, sending the backscattered transmission includes, after the indicated first duration from the WUR trigger packet, shifting energy of the one or more power packets on the first frequency channel to the second frequency channel during the third duration. In this implementation, the second channel is the indicated channel.

In some implementations, shifting energy of the one or more power packets on the first frequency channel to the second frequency channel during the third duration includes, for each received power packet of the one or more power packets: shifting energy of the power packet on the first frequency channel to second frequency channel without modulating data of the backscattering device on the second frequency channel during the second duration of the power packet preamble; and shifting energy of the power packet on the first frequency channel to second frequency channel and modulating data of the backscattering device on the second frequency channel after the second duration of the power packet preamble.

In some implementations, the methods and wireless communication devices include performing an association procedure with the AP before receiving the WUR trigger packet. The association procedure includes receiving a broadcast WUR poll frame from the AP; receiving a second one or more power packets from the AP on a third frequency channel; sending a backscattered association response frame to the AP on a fourth frequency channel using one the second one or more power packets; and receiving a WUR acknowledgment (ACK) frame from the AP.

In some implementations, the broadcast WUR poll frame includes a 3-bit type identifier (ID) field with a value different than a type ID of the WUR trigger packet, an R/A bit set to 0, a transmitter ID, a medium access control (MAC) ID of the AP, an address set to a first value, and a fourth duration from the WUR poll frame until transmission of the second one or more power packets; the second one or more power packets are transmitted for a fifth duration; the association response frame is sent after the fourth duration and during the fifth duration, and includes a MAC ID of the backscattering device, a random address value, and the transmitter ID; the WUR ACK frame includes the 3-bit type ID field with a value different than the type ID of the WUR trigger packet, the R/A bit set to 1, the transmitter ID, the MAC ID of the backscattering device, and the random address value; and the one or more parameters includes the random address value.

In some implementations, the WUR poll frame and the WUR ACK frame further includes a timer indicating a time for disassociation.

In some implementations, the WUR trigger packet, the one or more power packets, and the one or more backscattered transmissions comprises 802.11 packets.

One innovative aspect of the subject matter described in this disclosure can be implemented in a method for wireless communication by an access point (AP). The method generally includes sending a wake up radio (WUR) trigger packet to one or more backscattering devices indicating one or more parameters for backscattering transmission. The method generally includes sending one or more power packets to the one or more backscattering devices on a first frequency channel.

Another innovative aspect of the subject matter described in this disclosure can be implemented in a wireless communication device. The wireless communication device includes at least one modem and at least one processor communicatively coupled with the at least one modem. The at least one memory communicatively coupled with the at least one processor and storing processor-readable code that, when executed by the at least one processor in conjunction with the at least one modem, is configured to send a WUR trigger packet to one or more backscattering devices indicating one or more parameters for backscattering transmission; and send one or more power packets to the one or more backscattering devices on a first frequency channel.

Another innovative aspect of the subject matter described in this disclosure can be implemented in a wireless communication device. The wireless communication device includes an access point (AP). The mobile station includes at least one transceiver coupled to at least one modem; at least one antenna coupled to the at least one transceiver to wirelessly transmit signals output from the at least one transceiver and to wirelessly receive signals for input into the at least one transceiver; and a housing that encompasses the at least one modem, the at least one processor, the at least one memory, the at least one transceiver and at least a portion of the at least one antenna. The at least one memory communicatively coupled with the at least one processor and storing processor-readable code that, when executed by the at least one processor in conjunction with the at least one modem, is configured to send a WUR trigger packet to one or more backscattering devices indicating one or more parameters for backscattering transmission; and send one or more power packets to the one or more backscattering devices on a first frequency channel.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows a pictorial diagram of an example wireless communication network.

FIG. 2 shows an example protocol data unit (PDU) for transmitting a wake-up radio (WUR) frame according to some examples.

FIG. 3 shows a block diagram of an example wireless communication device.

FIG. 4A shows a block diagram of an example access point (AP).

FIG. 4B shows a block diagram of an example station (STA).

FIG. 5 shows an example backscattering scenario.

FIG. 6 shows an example backscattered transmission.

FIG. 7 shows a flowchart illustrating an example process for a WUR receiver backscattering device, according to some examples.

FIG. 8 shows an example backscattering scenario, according to some examples.

FIG. 9 shows an example listening phase, WUR phase, and data phase according to some examples.

FIG. 10 shows a flowchart illustrating an example process for a driver AP, according to some examples.

FIG. 11 shows an example of time division multiplexed (TDMed) backscattering transmissions, according to some examples.

FIG. 12 shows an example of frequency division multiplexed (FDMed) backscattering transmissions, according to some examples.

FIG. 13 shows an example WUR trigger frame format, according to some examples.

FIG. 14 is a call flow showing an example association phase, according to some examples.

FIG. 15 shows an example association phase, according to some examples.

FIG. 16 shows an example WUR association frame format, according to some examples.

FIG. 17 shows an example WUR poll frame format, according to some examples.

FIG. 18 shows an example WUR acknowledgment frame format, according to some examples.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to a WLAN wake-up radio (WUR) with backscattering. Some implementations more specifically relate to using and a Wi-Fi (e.g., 802.11ba) protocol stack with backscattering. In some implementations, an association mechanism may be used to allow coexistence of multiple APs (e.g., a basic service set (BSS)) and multiple backscatterers. In some implementations, the driver AP may have control over the backscattering devices under its BSS. In some implementations, the driver AP can use multiplexing techniques, such as time division multiple access (TDMA) and/or frequency division multiple access (FDMA) to increase the effective bandwidth of the system, which can be based on clear channel assessment (CCA) procedures done by the driver AP.

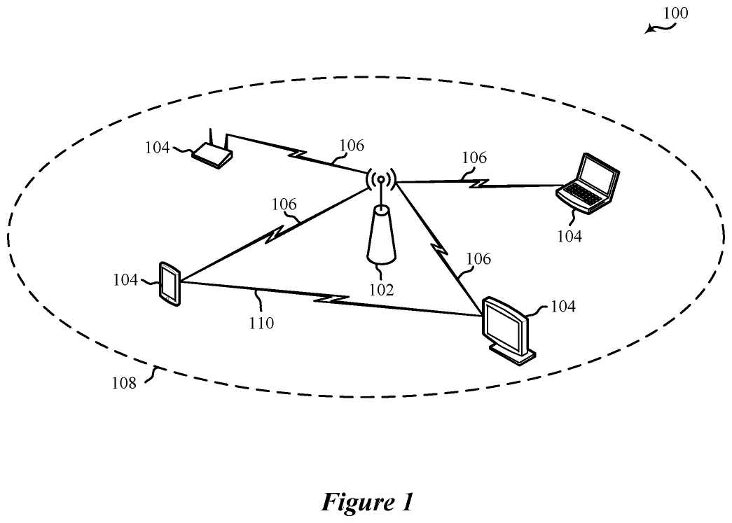

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

Some APs and STAs may be configured to transmit and receive wake-up signals, respectively. For example, an AP, such as the AP 102 described with reference to FIG. 1 may unicast, multicast or broadcast a wake-up signal to one or more intended recipient devices, such as the STAs 104 described with reference to FIG. 1. The AP may transmit a wake-up signal to an intended recipient STA to cause the STA to wake up, turn on, activate or otherwise enable a primary radio of the recipient STA from a sleep, off, low-power or deactivated state in which the primary radio is disabled from transmitting or receiving signals to or from other wireless communication devices. For example, the AP may determine that it has data to send to the STA and subsequently transmit a wake-up signal to cause the STA to activate its primary radio such that it can receive the data from the AP. The STA monitors for wake-up signals using a secondary, low-power radio (also referred to as a “wake-up radio”). For example, the secondary radio may have a power consumption that is less than 1 milliwatt (mW) in some implementations. Using the secondary radio enables the STA to sleep or otherwise be in a low-power state in which its primary radio is deactivated while still monitoring for signals using the secondary radio thereby reducing overall power consumption.

As will be discussed in more detail below, the wireless communication network 100 may use Wi-Fi backscattering and WUR packets.

In some implementations, the APs and STAs are configured to transmit and receive wake-up signals in the form of WUR packets. The WUR packets can be generated and transmitted according to a Wi-Fi protocol (e.g., IEEE 802.11ba). The wake-up signals, in the form of WUR packets, may include WUR Beacon frames enabling an AP to maintain timing synchronization between the it and associated STAs, WUR Wake-up frames enabling an AP to notify a STA that it has buffered data for the STA, WUR Discovery frame enabling low power discovery of WUR-compatible APs, and WUR Vendor Specific frames for supporting vendor specific operations.

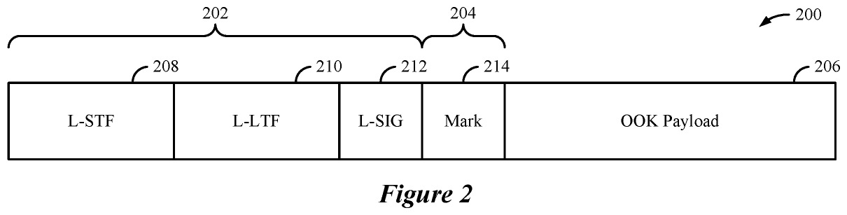

FIG. 2 shows an example PDU 200 for transmitting a wake-up radio frame according to some implementations. The PDU 200 includes a physical layer preamble that includes a first portion 202 followed by a second portion 204. The first portion 202 includes one or more symbols and the second portion 204 includes one or more symbols. Each of the symbols in the first portion 202 is modulated according to a binary phase shift keying (BPSK) modulation scheme. In some implementations, at least the first symbol in the second portion 204 also is modulated according to a BPSK modulation scheme. In some other implementations, one or more of the symbols in the second portion 204 is modulated according to a quadrature BPSK (Q-BPSK) modulation scheme.

In the implementation shown in FIG. 2, the first portion 202 of the PDU 200 is a legacy portion that includes L-STF 208, followed by L-LTF 210, which is followed by L-SIG 212. For example, in some implementations, the first portion 202 is generated according to the IEEE 802.11a communication protocol. In the implementation shown in FIG. 2, the second portion 204 includes only one symbol, a first symbol (Mark) 214 (in other implementations, the second portion 204 may include additional symbols).

The PDU 200 further includes a physical layer payload 206 following the preamble (for example, immediately following the second portion 204 of the preamble). In some implementations, the payload 206 includes multiple symbols modulated according to a multicarrier (MC) on-off keying (OOK) (MC-OOK) modulation scheme. For example, in some implementations the payload 206 is generated according to the IEEE 802.11ba communication protocol and includes a WUR Beacon frame, a WUR Wake-up frame, a WUR Discovery frame or a WUR Vendor Specific frame.

As will be discussed herein, the WUR packets may be used for backscattering. For example, the WUR packets may include parameters for the backscattering.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it must wait for a particular time and then contend for access to the wireless medium. In some implementations, the wireless communication device may be configured to implement the DCF through the use of carrier sense multiple access (CSMA) with collision avoidance (CA) (CSMA/CA) techniques and timing intervals. Before transmitting data, the wireless communication device may perform a clear channel assessment (CCA) and determine that the appropriate wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy. Virtual carrier sensing is accomplished via the use of a network allocation vector (NAV), an indicator of a time when the medium may next become idle. The NAV is reset each time a valid frame is received that is not addressed to the wireless communication device. The NAV effectively serves as a time duration that must elapse before the wireless communication device may contend for access even in the absence of a detected symbol or even if the detected energy is below the relevant threshold.

As described above, the DCF is implemented through the use of time intervals. These time intervals include the slot time (or “slot interval”) and the inter-frame space (IFS). The slot time is the basic unit of timing and may be determined based on one or more of a transmit-receive turnaround time, a channel sensing time, a propagation delay and a MAC processing time. Measurements for channel sensing are performed for each slot. All transmissions may begin at slot boundaries. Different varieties of IFS exist including the short IFS (SIFS), the distributed IFS (DIFS), the extended IFS (EIFS), and the arbitration IFS (AIFS). For example, the DIFS may be defined as the sum of the SIFS and two times the slot time. The values for the slot time and IFS may be provided by a suitable standard specification, such as one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be).

When the NAV reaches 0, the wireless communication device performs the physical carrier sensing. If the channel remains idle for the appropriate IFS (for example, the DIFS), the wireless communication device initiates a backoff timer, which represents a duration of time that the device must sense the medium to be idle before it is permitted to transmit. The backoff timer is decremented by one slot each time the medium is sensed to be idle during a corresponding slot interval. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has won contention for the wireless medium. If, on the other hand, one or more of the carrier sense mechanisms indicate that the channel is busy, a MAC controller within the wireless communication device will not permit transmission.

Each time the wireless communication devices generates a new PPDU for transmission in a new TXOP, it randomly selects a new backoff timer duration. The available distribution of the numbers that may be randomly selected for the backoff timer is referred to as the contention window (CW). If, when the backoff timer expires, the wireless communication device transmits the PPDU, but the medium is still busy, there may be a collision. Additionally, if there is otherwise too much energy on the wireless channel resulting in a poor signal-to-noise ratio (SNR), the communication may be corrupted or otherwise not successfully received. In such instances, the wireless communication device may not receive a communication acknowledging the transmitted PDU within a timeout interval. The MAC may then increase the CW exponentially, for example, doubling it, and randomly select a new backoff timer duration from the CW before each attempted retransmission of the PPDU. Before each attempted retransmission, the wireless communication device may wait a duration of DIFS and, if the medium remains idle, then proceed to initiate the new backoff timer. There are different CW and TXOP durations for each of the four access categories (ACs): voice (AC_VO), video (AC_VI), background (AC_BK), and best effort (AC_BE). This enables particular types of traffic to be prioritized in the network.

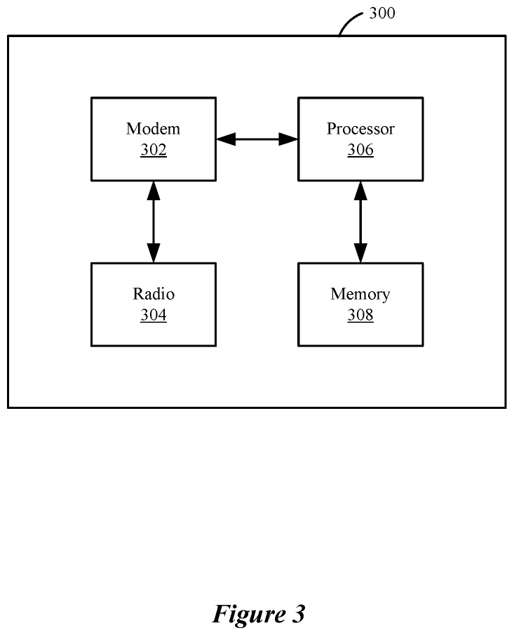

FIG. 3 shows a block diagram of an example wireless communication device 300. In some implementations, the wireless communication device 300 can be an example of a device for use in a STA such as one of the STAs 104 described above with reference to FIG. 1. In some implementations, the wireless communication device 300 can be an example of a device for use in an AP such as the AP 102 described above with reference to FIG. 1. The wireless communication device 300 is capable of transmitting (or outputting for transmission) and receiving wireless communications (for example, in the form of wireless packets). For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 300 can be, or can include, a chip, system on chip (SoC), chipset, package or device that includes one or more modems 302, for example, a Wi-Fi (IEEE 802.11 compliant) modem. In some implementations, the one or more modems 302 (collectively “the modem 302”) additionally include a WWAN modem (for example, a 3GPP 4G LTE or 5G compliant modem). In some implementations, the wireless communication device 300 also includes one or more radios 304 (collectively “the radio 304”). In some implementations, the wireless communication device 306 further includes one or more processors, processing blocks or processing elements 306 (collectively “the processor 306”) and one or more memory blocks or elements 308 (collectively “the memory 308”).

The modem 302 can include an intelligent hardware block or device such as, for example, an application-specific integrated circuit (ASIC) among other possibilities. The modem 302 is generally configured to implement a PHY layer. For example, the modem 302 is configured to modulate packets and to output the modulated packets to the radio 304 for transmission over the wireless medium. The modem 302 is similarly configured to obtain modulated packets received by the radio 304 and to demodulate the packets to provide demodulated packets. In addition to a modulator and a demodulator, the modem 302 may further include digital signal processing (DSP) circuitry, automatic gain control (AGC), a coder, a decoder, a multiplexer and a demultiplexer. For example, while in a transmission mode, data obtained from the processor 306 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 304. In implementations involving beamforming, the modulated symbols in the respective spatial streams are precoded via a steering matrix prior to their provision to the IFFT block.

While in a reception mode, digital signals received from the radio 304 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 306) for processing, evaluation or interpretation.

The radio 304 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one or more power amplifier (PA) and at least one low-noise amplifier (LNA), respectively. The RF transmitters and receivers may, in turn, be coupled to one or more antennas. For example, in some implementations, the wireless communication device 300 can include, or be coupled with, multiple transmit antennas (each with a corresponding transmit chain) and multiple receive antennas (each with a corresponding receive chain). The symbols output from the modem 302 are provided to the radio 304, which then transmits the symbols via the coupled antennas. Similarly, symbols received via the antennas are obtained by the radio 304, which then provides the symbols to the modem 302.

The processor 306 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 306 processes information received through the radio 304 and the modem 302, and processes information to be output through the modem 302 and the radio 304 for transmission through the wireless medium. For example, the processor 306 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 306 may generally control the modem 302 to cause the modem to perform various operations described above.

The memory 304 can include tangible storage media such as random-access memory (RAM) or read-only memory (ROM), or combinations thereof. The memory 304 also can store non-transitory processor- or computer-executable software (SW) code containing instructions that, when executed by the processor 306, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

As will be discussed in more detail herein, the wireless communication device 300 can use WLAN backscattering. For example, the wireless communication device 300 may be a driver AP, a backscattering device, and/or may receive backscattered signals, in accordance with aspects described herein.

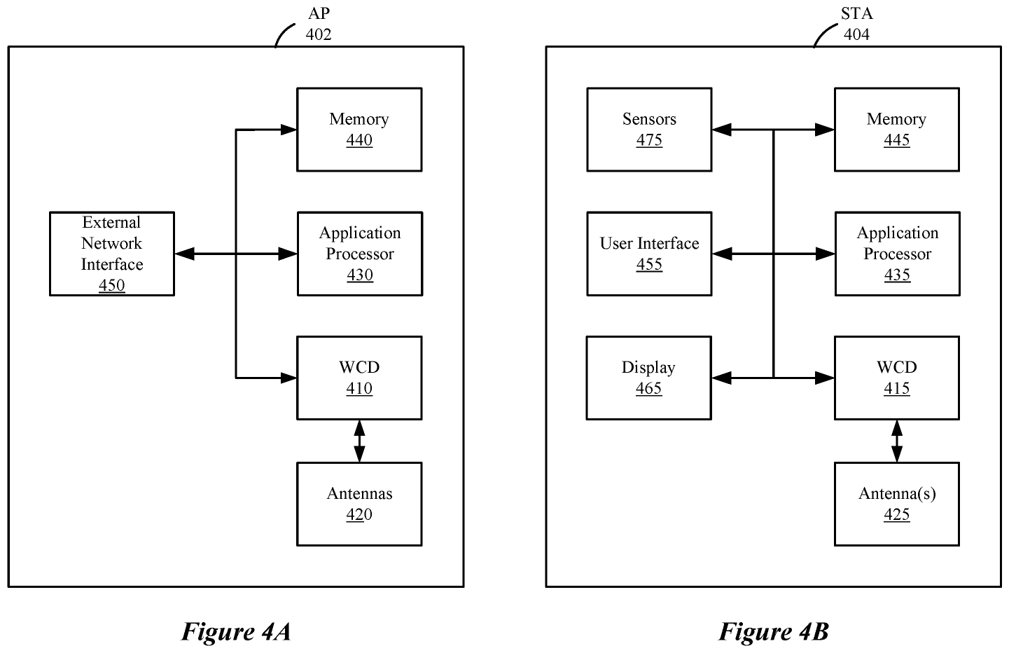

FIG. 4A shows a block diagram of an example AP 402. For example, the AP 402 can be an example implementation of the AP 102 described with reference to FIG. 1. The AP 402 includes a wireless communication device (WCD) 410 (although the AP 402 may itself also be referred to generally as a wireless communication device as used herein). For example, the wireless communication device 410 may be an example implementation of the wireless communication device 300 described with reference to FIG. 3. The AP 402 also includes multiple antennas 420 coupled with the wireless communication device 410 to transmit and receive wireless communications. In some implementations, the AP 402 additionally includes an application processor 430 coupled with the wireless communication device 410, and a memory 440 coupled with the application processor 430. The AP 402 further includes at least one external network interface 450 that enables the AP 402 to communicate with a core network or backhaul network to gain access to external networks including the Internet. For example, the external network interface 450 may include one or both of a wired (for example, Ethernet) network interface and a wireless network interface (such as a WWAN interface). Ones of the aforementioned components can communicate with other ones of the components directly or indirectly, over at least one bus. The AP 402 further includes a housing that encompasses the wireless communication device 410, the application processor 430, the memory 440, and at least portions of the antennas 420 and external network interface 450.

As will be discussed in more detail herein, the AP 402 can use WLAN backscattering. For example, the AP 402 may be a driver AP and/or may receive backscattered signals, in accordance with aspects described herein.

FIG. 4B shows a block diagram of an example STA 404. For example, the STA 404 can be an example implementation of the STA 104 described with reference to FIG. 1. The STA 404 includes a wireless communication device 415 (although the STA 404 may itself also be referred to generally as a wireless communication device as used herein). For example, the wireless communication device 415 may be an example implementation of the wireless communication device 300 described with reference to FIG. 3. The STA 404 also includes one or more antennas 425 coupled with the wireless communication device 415 to transmit and receive wireless communications. The STA 404 additionally includes an application processor 435 coupled with the wireless communication device 415, and a memory 445 coupled with the application processor 435. In some implementations, the STA 404 further includes a user interface (UI) 455 (such as a touchscreen or keypad) and a display 465, which may be integrated with the UI 455 to form a touchscreen display. In some implementations, the STA 404 may further include one or more sensors 475 such as, for example, one or more inertial sensors, accelerometers, temperature sensors, pressure sensors, or altitude sensors. Ones of the aforementioned components can communicate with other ones of the components directly or indirectly, over at least one bus. The STA 404 further includes a housing that encompasses the wireless communication device 415, the application processor 435, the memory 445, and at least portions of the antennas 425, UI 455, and display 465.

The STA 404 can be considered a subsystem of the AP 402. That is, the AP 402 may include the sensors 475, user interface 455, and display 465, and the components may be encompassed within a shared housing.

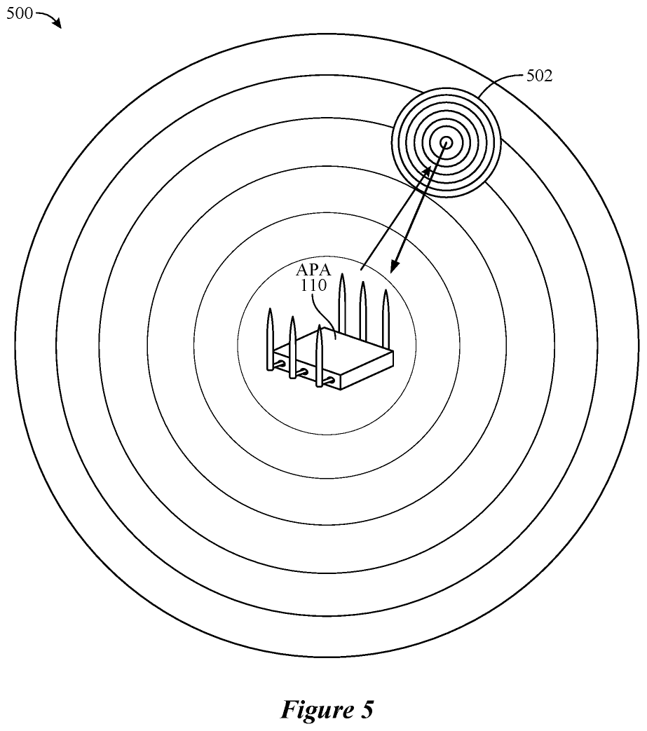

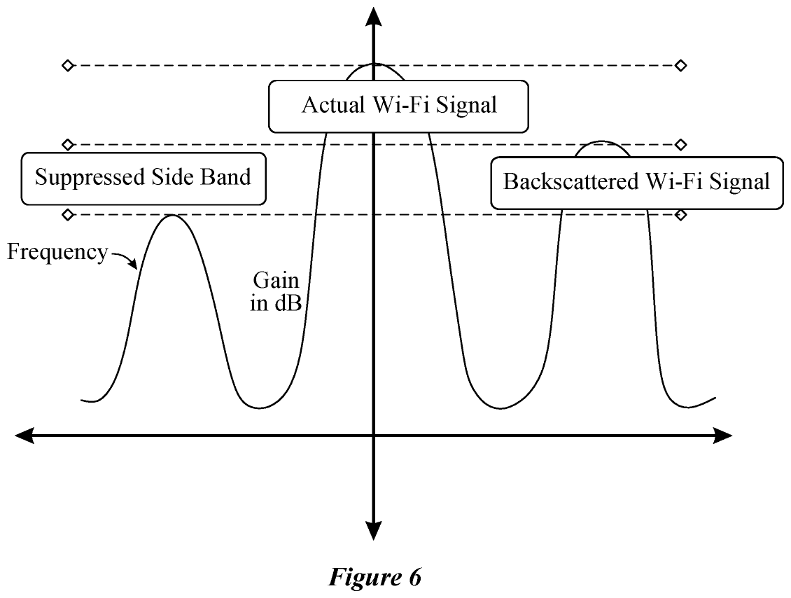

FIG. 5 shows an example backscattering scenario 500. As shown in FIG. 5, the AP 110 sends an original Wi-Fi signal. The backscatter tag 502 (e.g., a backscattering transmitter) backscatters the original Wi-Fi signal on a new channel, by shifting energy of the original Wi-Fi signal to the new channel and can modulate its data on the signal. As shown, the AP 110 can receive the the backscattered signal. The AP 110 can synchronize and correlate the original and backscattered Wi-Fi signals and extract the backscattered data modulated on the backscattered signal. FIG. 6 shows an example backscattered transmission.

It is desirable for certain Wi-Fi systems that work in the unlicensed band to coexist with other devices in the same channel. Clear Channel Assessment (CCA) may be done to facilitate the coexistence. Conventional backscattering devices do not have a channel specific receiver and, therefore, a CCA feedback mechanism is not supported. Specifically, such backscattering devices do not have any support for any Wi-Fi protocol stack.

For transferring Wi-Fi frames coming from a driver AP and backscattering it to another channel by the backscattering transmitter, the preamble portion of the power packet should remain uncorrupted, otherwise the backscattered packet will be dropped by the receiver. The backscattering transmitter may not have fast Fourier transform (FFT) decoder (e.g., due to high power consumption) to decode the preamble portion. Without the FFT decoder, the backscattering transmitter waits for a certain duration of time after receiving the Wi-Fi packet before it phase modulates that power packet with backscattering data. This means that backscattering will happen for any packet (not only for power packets) captured by the backscattering device. This leads to wastage of bandwidth and power of valid Wi-Fi signals from the surrounding environment.

Also, conventional backscattering may not allow multiple access of the channel by various backscattering device (e.g., because there is no feedback to detect collisions).

Aspects of the present disclosure provide for backscattering that may compliant with Wi-Fi standards. The backscattering techniques may allow control by the driver AP over the backscattering transmitter to perform CCA and time synchronization. The techniques may allow for the duty cycle to be controlled to save power.

According to certain aspects, the driver AP can signal backscattering parameters to the backscattering device. Thus, the driver AP, which does CCA, can control the backscattering and can coordinate backscattering by multiple device. In some examples, the driver AP can use a Wi-Fi protocol (e.g., 802.11ba protocol) to send WUR packets with the backscattering parameters (referred to hereinafter as a WUR trigger packet). The backscattering device may be an WUR enabled backscattering transmitter (WeBT). The WeBT can include an OOK receiver which may consume low power (e.g., relative to high power receives such as FFT receivers).

In some examples, the driver AP can first transmit the WUR trigger packet to signal the backscatter for the upcoming transmission and then send out the power packets to be backscattered.

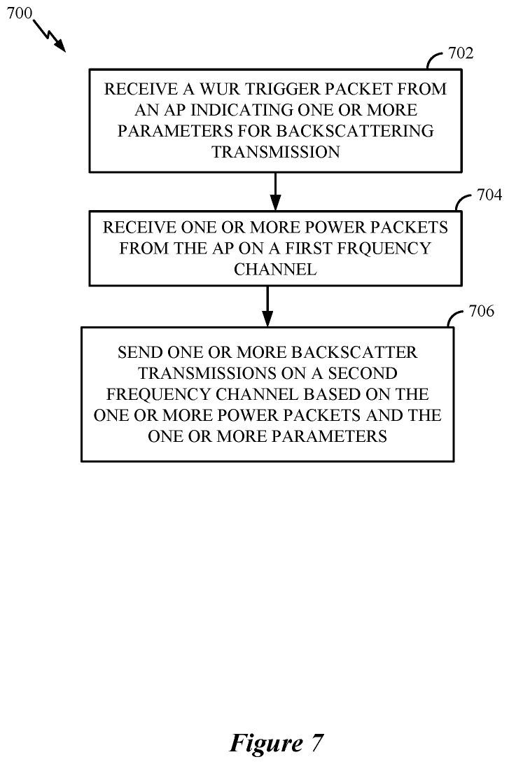

FIG. 7 shows a flowchart illustrating an example process 700 for WUR with Wi-Fi backscattering according to some implementations. The operations of process 700 may be implemented by an STA or its components as described herein. For example, the process 700 may be performed by a wireless communication device such as the wireless communication device 300 described above with reference to FIG. 3. In some implementations, the process 700 may be performed by an STA, such as one of the STAs 104 and 404 described above with reference to FIGS. 1 and 4B, respectively.

In some implementations, in block 702, the wireless communication device 300 receives a wake up radio (WUR) trigger packet from an access point (AP) indicating one or more parameters for backscattering transmission. In block 704, the wireless communication device 300 receives one or more power packets from the AP on a first frequency channel. In block 706, the wireless communication device sending one or more backscattered transmissions on a second frequency channel based on the one or more power packets and the one or more parameters.

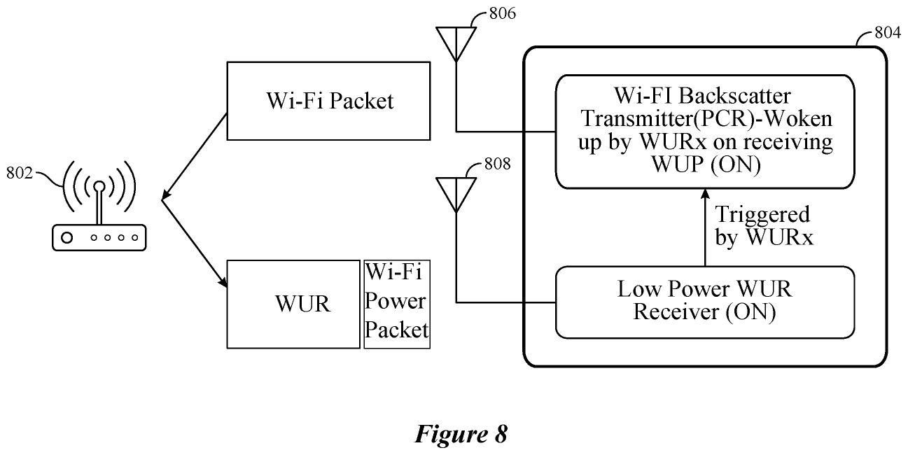

In some implementations, a receiver, such as an OOK receiver, receives WUR frames during a listening phase. Receiving the WUR trigger packet in block 702 includes receiving a Wi-Fi (e.g., 802.11ba) WUR packet from the driver AP (or power AP) 802 at the backscattering device 804, as shown in FIG. 8. As shown in FIG. 8, after receiving the WUR trigger packet (e.g., via antenna 808), the backscattering device 804 turns on its low power WUR receiver which may trigger turning on the Wi-Fi backscatter transmitter. In the data phase, the same receiver receives and backscatters the Wi-Fi power packets (e.g., via antenna 806) from the driver AP, thus saving bandwidth and unnecessary use of AP power packets. For frame synchronization, the incoming Wi-Fi power packet and the start of backscattering may occur simultaneously or in phase. To assist in frame detection, the WUR receiver may listen to power packets to get the timing for the frame edge to start the trigger by WUR to enable frequency modulation in the Wi-Fi backscatter. In some examples, the backscattering device 804 is a low power Internet-of-Things (IoT) communication device.

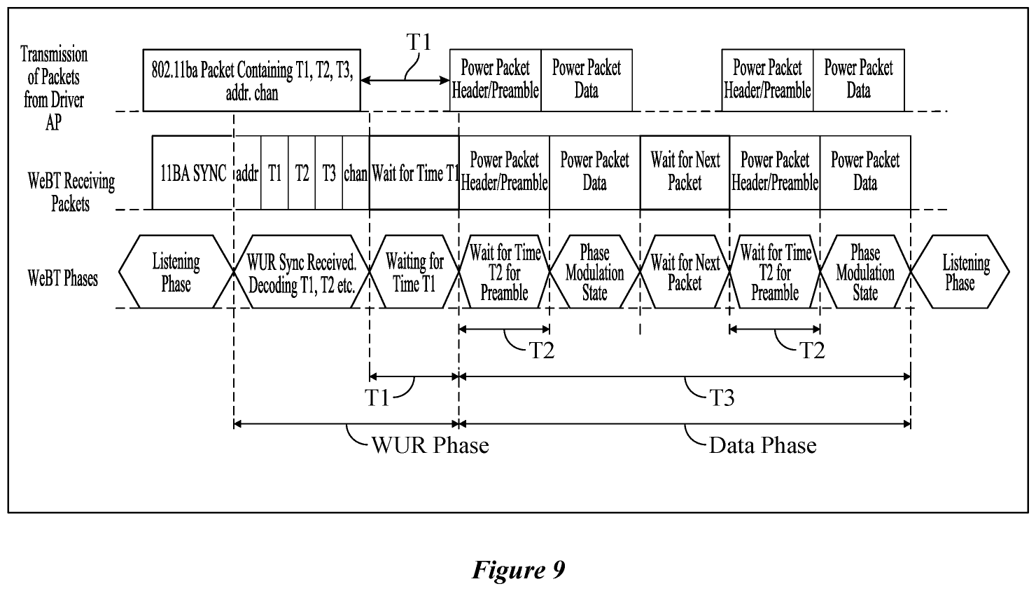

In some implementations, a receiver (e.g., an OOK receiver) monitors/receives power packets and WUR frames. Receiving the WUR trigger packet in block 702 includes listening for WUR packets during listening phase, as shown in FIG. 9. In some implementations, when the backscattering device 804 receives a packet that does not include backscattering parameters, the backscattering device 804 does not perform backscattering. For example, the backscattering device 804 does not turn on the Wi-Fi backscatter transmitter and does not enter the WUR phase shown in FIG. 9.

As shown in FIG. 9, the WUR backscattering protocol may include a listening phase, a WUR phase, and a data phase.

During the listening phase, the driver AP can transmit the WUR trigger packet containing the backscattering parameters. The backscattering transmitter can perform 11BA synchronization and decode the WUR trigger packet to obtain the backscattering parameters. During the listening phase, the backscattering transmitter waits for WUR packets to come. No backscattering transmission happens during the listening phase, even if the backscattering transmitter receives a Wi-Fi packet.

In some implementations, the one or more parameters indicate a first duration from the WUR trigger packet until detecting of the one or more the power packets starts, a second duration indicating a duration of a preamble of the one or more power packets during each of which backscattering is without modulation of data of the backscattering device on the second frequency channel, a third duration for the one or more backscattered transmissions, an address of the backscattering device, the second frequency channel for the one or more backscattered transmissions, or a combination thereof. As shown in FIG. 9, the backscattering parameters may include a T1 parameter, a T2 parameter, a T3 parameter, an address parameter, and a channel parameter. The T1 parameter may indicate a transmit start time—the time after which backscattering transmission starts. The T2 parameter may indicate a preamble wait time—the preamble duration of the power packet is a time for preamble backscattering without any modulation, so that the preamble does not get corrupted by modulation. The T3 parameter may indicate a transmit duration—the time for which backscattering can take place (e.g., data is transferred to the new channel) and phase modulation can be performed where backscattering data is modulated over the power packet and transmitted. Thus, backscattering may be done after the T1 time and lasts for the T3 time. Each backscattering device may be provided with an address. The address parameter may be used by the driver AP in the WUR trigger packet to schedule which backscattering device is to perform the backscattering. The channel parameter may indicate which channel to backscatter onto.

As shown in FIG. 9, during the WUR phase, after decoding the WUR trigger packet and obtaining the backscattering parameters, the backscattering device may identify that it is the intended recipient and backscatterer based on the address field in the WUR trigger packet. The backscattering device waits for the T1 time. After the T1 time, the data phase may begin during which the backscattering device performs backscattering for the T3 duration

As shown in FIG. 9, during the data phase, the driver AP may begin sending the power packets, including a power packet header/preamble and power packet data. During the time T2, the backscattering device receives the power packet header/preamble and performs backscattering without any modulation. After the T2 time, the backscattering device performs backscattering with phase modulation to modulate data on to the signal. The backscattering device backscatters onto the channel indicated by the channel parameter in the WUR trigger packet.

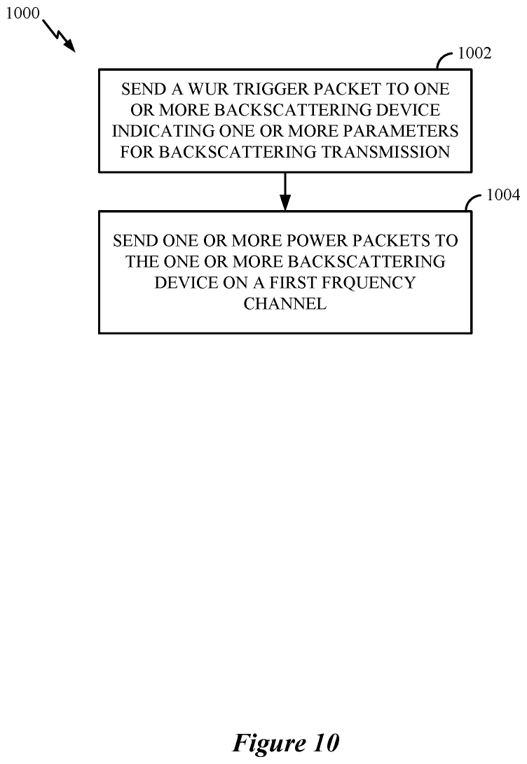

FIG. 10 shows a flowchart illustrating an example process 1000 for WUR with Wi-Fi backscattering according to some implementations. The operations of process 1000 may be implemented by a driver AP or its components as described herein. For example, the process 1000 may be performed by a wireless communication device such as the wireless communication device 300 described above with reference to FIG. 3. In some implementations, the process 1000 may be performed by an AP, such as one of the APs 102 and 402 described above with reference to FIGS. 1 and 4A, respectively.

In some implementations, in block 1002, the wireless communication device 300 sends a WUR trigger packet to one or more backscattering devices indicating one or more parameters for backscattering transmission. In block 1004, the wireless communication device 300 sends one or more power packets to the one or more backscattering device on a first frequency channel.

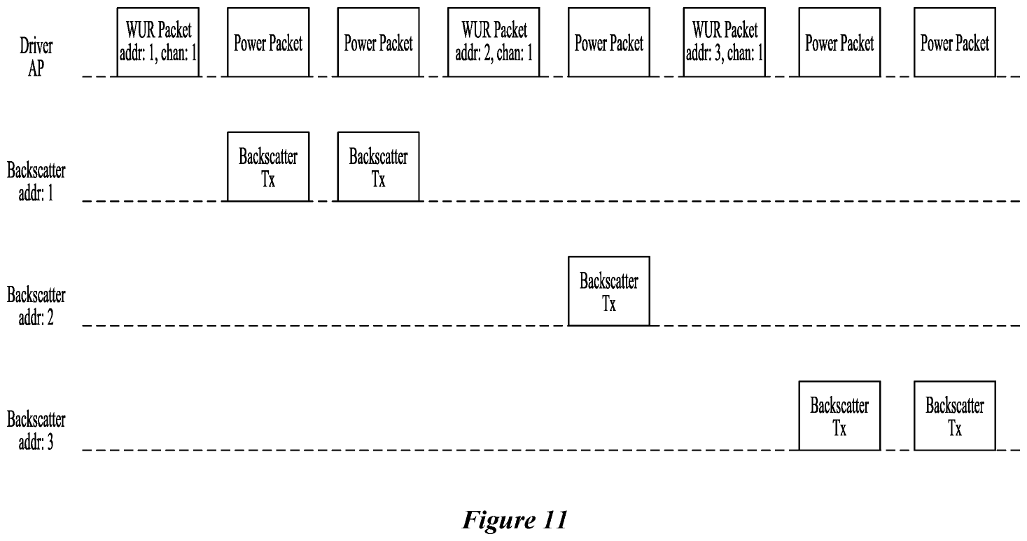

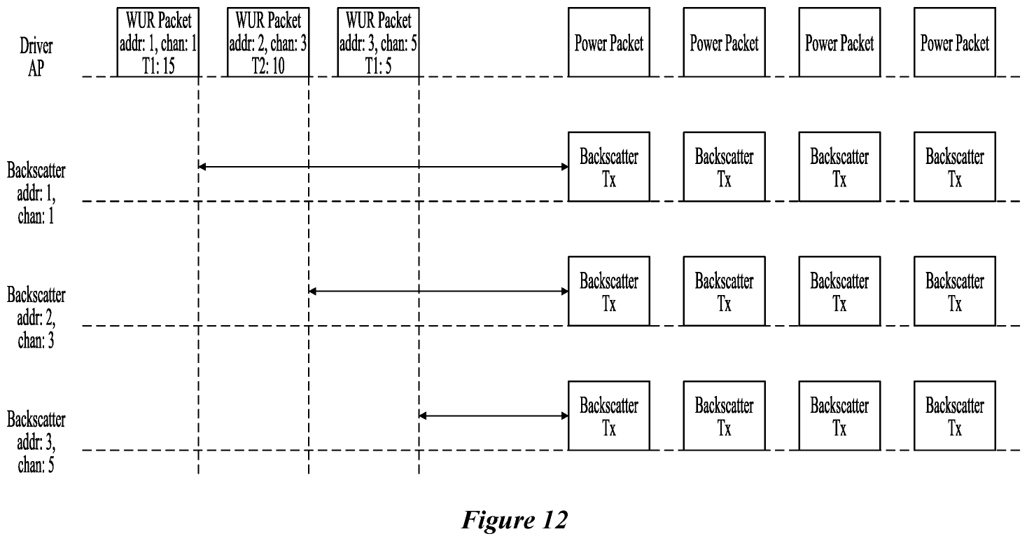

In some implementations, the driver AP can send the address parameter to schedule which backscatter should be allowed to transmit in the channel and for what duration (given by T1 and T3), thus allowing multiple access of the channel and effective use the channel. For example, by knowing the buffer capacity of each backscatter, the driver AP can schedule the backscattering devices as different times for time division multiple access (TDMA) as shown in FIG. 11. The driver AP can send the channel parameter to allocate separate channels to each backscatter for frequency division multiple access (FDMA) as shown in FIG. 12. For example, based on CCA, the driver AP can tell the backscattering devices which channel to backscatter onto. In some implementations, the driver AP may use both TDMA and FDMA.

In some implementations, before sending the WUR trigger packet in block 1002, the wireless communication device 300 listens to all the channels. This way, the wireless communication device 300 can provides relevant information to the backscattering device via the WUR packets.

The wireless communication device 300 may periodically or based on certain conditions schedule backscattering transmission by sending the WUR packet containing the backscattering parameters. After the T1 time, in the block 1004, the wireless communication device 300 may start transmitting the power packets (e.g. 802.11g packets) with predefined data patterns known to both the backscattering transmitter and the driver AP. The wireless communication device 300 may transmit power packets for the T3 duration. After completion of one transmission, the wireless communication device 300 can reallocate the same or different channel to the same backscattering device or allocate it to some other backscattering device after doing the CCA, thus allowing multiple access.

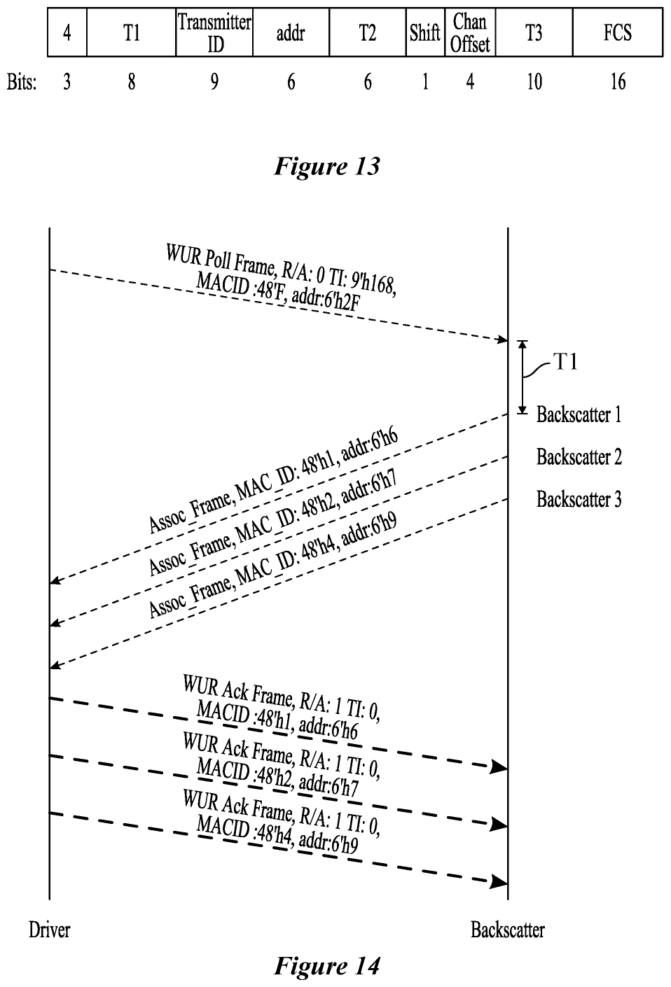

For integration with the Wi-Fi protocol stack, a modified MAC frame format may be used. As shown in FIG. 13, the WUR frame format 1300 may be extended. For example, the WUR MAC frame format 1300 may include 22 bytes. The WUR MAC frame format 1300 may include a modified frame control field. The modified frame control field (e.g., an 8 or 11-bit field) may include a type field (e.g., a 3-bit field) that may be set to a reserved value (e.g., the values 4-7 may be reserved) and a T1 field that may be used to indicate the T1 parameter. The WUR MAC frame format 1300 may include the transmitter ID field (e.g., 9-bits) which may indicate the 9 least significant bits (LSBs) of the compressed BSSID of the driver AP, address field (e.g., 6-bits), T2 field (e.g., 6 bits), shift field (e.g., 1 bit), channel offset field (e.g., 4 bits), T3 field (e.g., 10 bits), and frame check sequence (FCS) field (e.g., 16 bits). The shift field may represent the lower subband (0) or upper subband (1) with respect to the driver AP channel frequency. The channel offset field (e.g., a 5 MHz channel offset) may represent the channel the backscattering device uses for transmitting in FDMA mode. In some examples, the channel can be determine as: (Driver AP channel in MHz)−[(−1)^{shift field}×(channel offset)×5 MHz]. Valid channel may include: (Channel number of Driver AP)−[(channel offset)×(−1)^{shift field}]_{ϵ}[1, 13]. The FCS field contains the cyclic redundancy check (CRC).

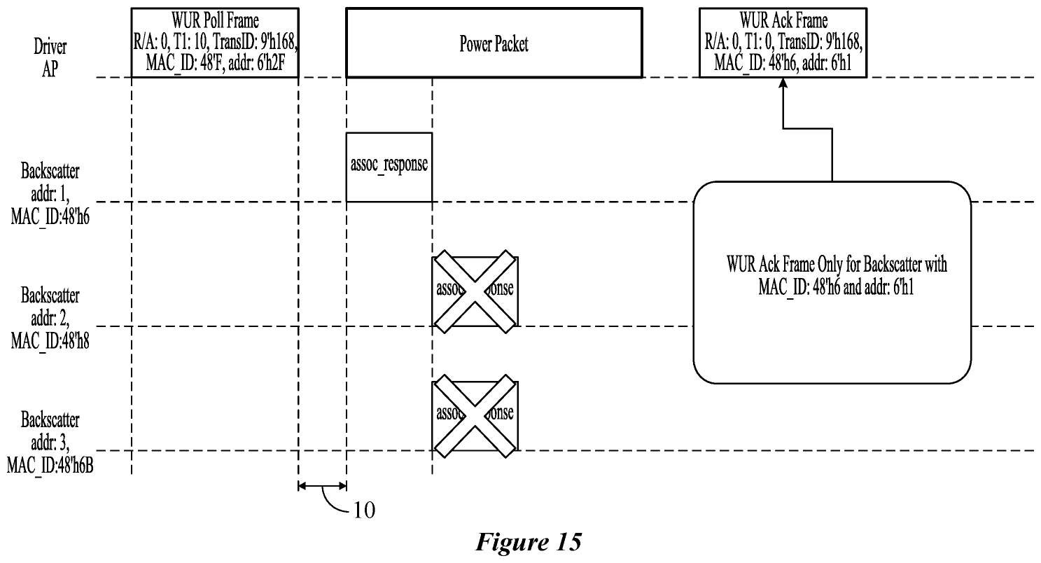

The driver AP and backscattering device(s) may also perform an association. For example, the association may provide secure communications. For example, the association phase may be performed before the phases shown in FIG. 9. FIGS. 14 and 15 showing example association phases, according to some examples. As shown, the association phase may begin with the driver AP broadcasting a WUR poll frame to the backscattering devices. FIG. 17 shows an example WUR poll frame format 1700, according to some examples. As shown in FIG. 17, the WUR poll frame format 1700 may include the type field set to a reserved value (e.g., a different reserved value than the WUR trigger frame, such 5). The WUR poll frame format includes an optional R/A bit set to 0, the transmitter ID field, a medium access control (MAC) ID of the AP, an address set to a first value, and a duration from the WUR poll frame until transmission of the power packets.

After time T1, the driver AP will start sending long power packets for a predetermined time T3, as shown in FIG. 15. The predetermined time T3 may be known to the backscattering device.

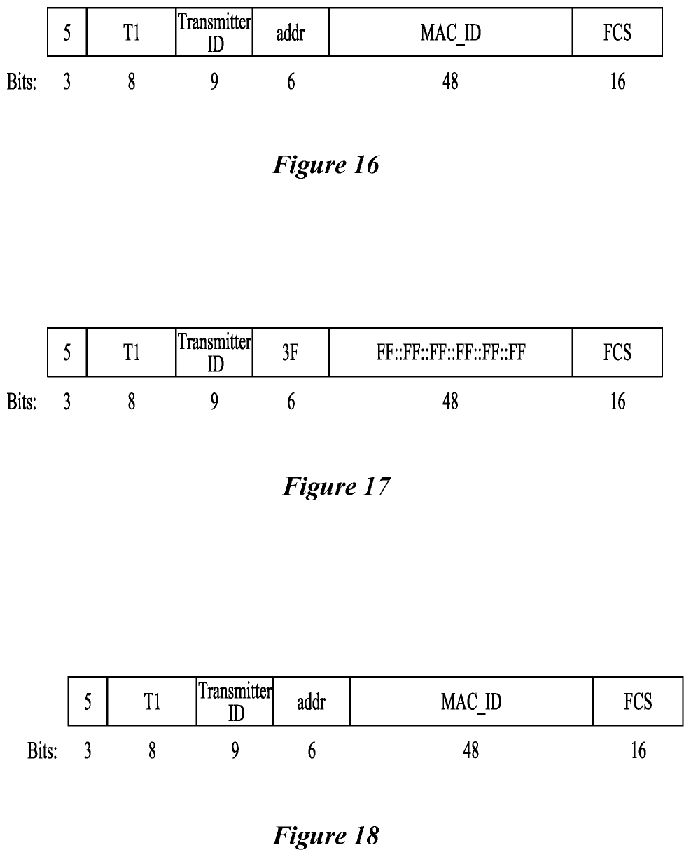

The backscattering devices may wait for a random time and then backscatter the power packets to respond with an association response frame. The backscattering device may wait for a time T1 and a default time T2, which may be known to both the driver AP and the backscattering device. FIG. 16 illustrates an example association response frame 1600, according to some examples. The association frame 1600 may include a MAC ID of the backscattering device, a random address value, and the transmitter ID sent in the WUR frame.

After the driver AP receives the backscattered association frame, it registers the fields and sends out an Acknowledgement WUR Frame. The driver AP may send a WUR acknowledgment frame to the backscattering devices from which it receives an association response frame. FIG. 18 illustrates an example WUR ACK frame 1800. The WUR ACK frame may include the type ID field (e.g., 3 bits) with a value different than the type ID of the WUR trigger packet, the R/A bit set to 1, the transmitter ID (e.g., 9-bits of transmitter ID), the MAC ID of the backscattering device, and the random address value.

In some implementations, if multiple backscattering devices respond back with the same address, the driver AP does not acknowledge any of the backscattering devices and resends a WUR Poll frame again.

In some implementations, upon a successful association, the driver AP create a backscattering list including the MAC ID, address, channel to be used, and backscattering transmission duration of associated backscattering devices. The information can be dynamically updated based on CCA information available at the driver AP and used for the processing of the backscattering data.

In some implementations, the WUR poll frame and the WUR ACK frame includes a timer indicating a time for disassociation.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communication by a backscattering device, comprising:
receiving a wake up radio (WUR) trigger packet from an access point (AP) indicating one or more parameters for backscattering transmission;
receiving one or more power packets from the AP on a first frequency channel; and
sending one or more backscattered transmissions on a second frequency channel based on the one or more power packets and the one or more parameters.

2. The method of claim 1, wherein the backscattering device does not perform backscattering transmission for any received packet when a WUR trigger packet indicating the one or more parameters is not received.

3. The method of claim 1, wherein the one or more parameters indicate a first duration from the WUR trigger packet until detecting of the one or more the power packets starts, a second duration indicating a duration of a preamble of the one or more power packets during each of which backscattering is without modulation of data of the backscattering device on the second frequency channel, a third duration for the one or more backscattered transmissions, an address of the backscattering device, the second frequency channel for the one or more backscattered transmissions, or a combination thereof.

4. The method of claim 3, wherein the one or more parameters schedule a plurality of backscattering devices using time division multiplexing (TDM), frequency division multiplexing (FDM), or both.

5. The method of claim 3, wherein the WUR trigger packet comprises a medium access control (MAC) frame including a 3-bit type identifier (ID) field with a reserved value, an 8-bit field indicating the first duration, a 9-bit field indicating an ID of the AP comprising 9 least significant bits (LSBs) of a compressed basic service set ID (BSSID), a 6-bit field indicating the address of the backscatter device, a 6-bit field indicating the second duration, a 1-bit shift field and a 4-bit channel offset field indicating the second frequency channel, a 10-bit field indicating the third duration, and a 16-bit frame check sequence (FCS) field.

6. The method of claim 3, wherein sending the backscattered transmission comprises:
after the indicated first duration from the WUR trigger packet, shifting energy of the one or more power packets on the first frequency channel to the second frequency channel during the third duration, wherein the second channel is the indicated channel.

7. The method of claim 6, wherein shifting energy of the one or more power packets on the first frequency channel to the second frequency channel during the third duration comprises, for each received power packet of the one or more power packets:
shifting energy of the power packet on the first frequency channel to second frequency channel without modulating data of the backscattering device on the second frequency channel during the second duration of the power packet preamble; and
shifting energy of the power packet on the first frequency channel to second frequency channel and modulating data of the backscattering device on the second frequency channel after the second duration of the power packet preamble.

8. The method of claim 1, further comprising performing an association procedure with the AP before receiving the WUR trigger packet, wherein the association procedure comprises:
receiving a broadcast WUR poll frame from the AP;
receiving a second one or more power packets from the AP on a third frequency channel;
sending a backscattered association response frame to the AP on a fourth frequency channel using one the second one or more power packets; and
receiving a WUR acknowledgment (ACK) frame from the AP.

9. The method of claim 8, wherein:
the broadcast WUR poll frame includes a 3-bit type identifier (ID) field with a value different than a type ID of the WUR trigger packet, an R/A bit set to 0, a transmitter ID, a medium access control (MAC) ID of the AP, an address set to a first value, and a fourth duration from the WUR poll frame until transmission of the second one or more power packets;
the second one or more power packets are transmitted for a fifth duration;
the association response frame is sent after the fourth duration and during the fifth duration, and includes a MAC ID of the backscattering device, a random address value, and the transmitter ID;
the WUR ACK frame includes the 3-bit type ID field with a value different than the type ID of the WUR trigger packet, the R/A bit set to 1, the transmitter ID, the MAC ID of the backscattering device, and the random address value; and
the one or more parameters includes the random address value.

10. The method of claim 1, wherein the WUR poll frame and the WUR ACK frame further includes a timer indicating a time for disassociation.

11. The method of claim 1, wherein the WUR trigger packet, the one or more power packets, and the one or more backscattered transmissions comprises 802.11 packets.

12. A method for wireless communication by an access point (AP), comprising:
sending a wake up radio (WUR) trigger packet to one or more backscattering devices indicating one or more parameters for backscattering transmission; and
sending one or more power packets to the one or more backscattering devices on a first frequency channel.

13. The method of claim 12, further comprising:
receiving one or more backscattered transmissions from the one or more backscattering devices on a second frequency channel, the one or more backscattered transmissions based on the one or more power packets and the one or more parameters indicated in the WUR trigger packet.

14. The method of claim 12, wherein the one or more parameters indicate a first duration from the WUR trigger packet until detecting of the one or more the power packets starts, a second duration indicating a duration of a preamble of the one or more power packets during each of which backscattering is without modulation of data of the backscattering device on the second frequency channel, a third duration for the one or more backscattered transmissions, an address of the backscattering device, the second frequency channel for the one or more backscattered transmissions, or a combination thereof.

15. The method of claim 14, further comprising:
performing a clear channel assessment (CCA) procedure; and
determining the first duration and the third duration based on the CCA procedure.

16. The method of claim 14, wherein the one or more parameters schedule a plurality of backscattering devices using time division multiplexing (TDM), frequency division multiplexing (FDM), or both.

17. The method of claim 14, wherein the WUR trigger packet comprises medium access control (MAC) frame including a 3-bit type identifier (ID) field with a reserved value, an 8-bit field indicating the first duration, a 9-bit field indicating an ID of the AP comprising 9 least significant bits (LSBs) of a compressed basic service set ID (BSSID), a 6-bit field indicating the address of the backscatter device, a 6-bit field indicating the second duration, a 1-bit shift field and a 4-bit channel offset field indicating the second frequency channel, a 10-bit field indicating the third duration, and a 16-bit frame check sequence (FCS) field.

18. The method of claim 12, further comprising performing an association procedure with the backscattering device before sending the WUR trigger frame, wherein the association procedure comprises:
sending a broadcast WUR poll frame to the backscattering device;
sending a second one or more power packets to the backscattering device on a third frequency channel;
receiving a backscattered association response frame from the backscattering device on a fourth frequency channel using the one or more power packets; and
sending a WUR acknowledgment (ACK) frame to the backscattering device.

19. The method of claim 18, wherein:
the broadcast WUR poll frame includes a 3-bit type identifier (ID) field with a value different than a type ID of the WUR trigger packet, an R/A bit set to 0, a transmitter identifier (ID), a medium access control (MAC) ID of the AP, an address set to a first value, and a fourth duration from the WUR poll frame until transmission of the second one or more power packets;
the second one or more power packets are transmitted for a fifth duration;
the association response frame is received after the fourth and during the fifth duration, and includes a MAC ID of the backscattering device, a random address value, and the transmitter ID;
the WUR ACK frame includes the 3-bit type ID field with a value different than the type ID of the WUR trigger packet, the R/A bit set to 1, the transmitter ID, the MAC ID of the backscattering device, and the random address value; and
the one or more parameters includes the random address value.

20. A wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to:
receive a wake up radio (WUR) trigger packet from an access point (AP) indicating one or more parameters for backscattering transmission;
receive one or more power packets from the AP on a first frequency channel; and
send one or more backscattered transmissions on a second frequency channel based on the one or more power packets and the one or more parameters.
